(19) United States
(12) Patent Application Publication
(10) Pub. No.: US 2023/0221048 A1
(43) Pub. Date: Jul. 13, 2023

(54) REFRIGERATION APPLIANCE AND EVAPORATOR THEREFOR

(71) Applicant: BSH Hausgeräte GmbH, München (DE)

(72) Inventors: Giuseppe Cascino, Heidenheim (DE); Horst Drotleff, Aalen (DE); Daniel Micko, Ulm (DE); Katharina Plodek, Sontheim/Brenz (DE)

(21) Appl. No.: 18/009,802

(22) PCT Filed: May 26, 2021
(86) PCT No.: PCT/EP2021/064054

§ 371 Date: Dec. 12, 2022

(30) Foreign Application Priority Data
Jun. 16, 2020 (DE) 10 2020 207 393.7

(51) Int. Cl. F25B 39/02

(52) U.S. Cl. CPC F25B 39/022; F25B 2339/023; F25B 2500/12

(57) ABSTRACT

An evaporator for a refrigeration appliance has a refrigerant line, which extends from an injection point to an outlet of the evaporator. A number of heat exchanger plates are in thermal contact with the refrigerant line and with the surroundings of the evaporator. The refrigerant line has, in an upstream region of the evaporator, at least one constriction, which is spaced apart from the injection point.

The present invention relates to a refrigeration appliance, in particular a household refrigeration appliance, and to an evaporator which can be used in such a refrigeration appliance.

In particular in the case of refrigeration appliances used in living spaces, low operating noise is an important quality criterion. Up to now the developers' endeavors to reduce the operating noise of refrigeration appliances have essentially concentrated on the compressor, since its motor is the only actively moving component in a refrigeration appliance, and resonance vibrations of any components of the refrigeration appliance, which vibrations are audible as operating noise, are essentially attributable to excitation caused by vibrations emanating from the compressor.

It is only when the endeavors to suppress the operating noise traced back to the compressor have largely become successful that other noise sources come to the fore. Among these the most important is the refrigerant which expands at an injection point of the evaporator; in particular abruptly alternating flow speeds, which result when liquid and gaseous refrigerant escape alternately at the injection point, may result in an audible noise emission.

An object of the present invention is to create an evaporator with reduced operating noise emission or a refrigeration appliance in which the contribution of the evaporator to the operating noise emission is minimized.

The object is achieved on the one hand by, in the case of an evaporator for a refrigeration appliance, having a refrigerant line which extends from an injection point to an outlet of the evaporator and a number of heat exchanger plates, each of which is in thermal contact with the refrigerant line and with the surroundings of the evaporator, the refrigerant line having, in an upstream region of the evaporator, at least one constriction which is spaced apart from the injection point.

While the narrow cross-section of the injection point forces a high entrance speed of the refrigerant into the evaporator and is thus ultimately the main cause of a flow noise emitted by the evaporator, surprisingly a further narrow cross-section at the said constriction brings about a noise reduction. It can be assumed that the constriction hinders the propagation of a compression wave in the evaporator, which, with each phase change of the refrigerant injected at the injection point, propagates along the refrigerant line of the evaporator. The surface upon which the refrigerant can excite the line to vibrate is therefore significantly restricted, and the tendency of the refrigerant line to emit operating noise or to excite other components of the refrigeration appliance to emit noise is accordingly low.

To ensure that the constriction has a significant impact, its free cross-section should be significantly smaller than that of the refrigerant line away from the constriction; it is preferably smaller than a quarter, but better still smaller than a tenth of the free cross-section away from the constriction. On the other hand, it should be significantly larger than that of the injection point so that the constriction does not merely replace the injection point as the source of the noise.

For the same reason, the length of the constriction should also be small, e.g. smaller than the diameter of the refrigerant line away from the constriction. If, as is highly desirable for the purpose of flow, the free cross-section changes continuously through the constriction, the length of the constriction requires a definition; e.g. the length can be assumed to be the distance between two points of the constriction at which the free cross-section is in each case twice as large as at a narrowest point arranged therebetween.

The distance of each constriction from the injection point or from an adjacent injection point should be a multiple of the diameter of the refrigerant line, in order to some extent to buffer pressure fluctuations in the intermediate space between the constriction and injection point or between two constrictions, which pressure fluctuations result from a phase change of the refrigerant escaping at the injection point, and to be able to keep them away from the part of the refrigerant line which is disposed downstream of the constriction.

The refrigerant line and each heat exchanger plate are preferably components which differ from one another and are connected to one another in particular by means of clamping, adhesion and/or soldering. The refrigerant line can be manufactured cost-effectively as a pipe with a constant cross-section.

In particular, a constriction can be obtained on such a pipe in a conceivably simple manner by impressing a wall.

The refrigerant line preferably runs in a straight line between the injection point and the at least one constriction, in order to avoid a deflection of the compression wave on the wall which would enable an efficient excitation of vibrations of the refrigerant line.

The invention can be applied to various designs of evaporators, e.g. tube-on-sheet evaporators, in which the refrigerant line is formed by a pipe placed on a base plate. The application on a fin evaporator is particularly preferred, i.e. an evaporator with a plurality of heat exchanger plates through which the refrigerant line passes transversely, since unlike with a cold wall evaporator, these are surrounded on both sides by air into which they can transmit vibrations excited by the flowing refrigerant.

According to a first embodiment, the at least one constriction is formed on a section of the refrigerant line which extends between the injection point and a most upstream contact point of the refrigerant line with the number of heat exchanger plates; such a section is easily accessible at any time before or after assembly of the evaporator in order to mold the at least one constriction therein.

According to another, more compact embodiment, the at least one constriction is formed in a piece of the refrigerant line that extends in turn through the number of heat exchanger plates of the fin evaporator. If the constriction is formed before assembly of the fin evaporator, this can result in a deformation of the line cross-section which renders impossible an insertion of the refrigerant line into tightly tolerated, prefabricated holes in the heat exchanger plates. Consequently the at least one constriction is here preferably molded after assembly, by a tool being inserted between two heat exchanger plates in order to mold the constriction in a section of the refrigerant line which extends between the two heat exchanger plates.

The object is achieved on the other hand by a refrigeration appliance having an evaporator as described above.

The invention is particularly effective on a refrigeration appliance in which the at least one heat exchanger plate is in contact with air and is not for instance damped by contact with an inner container or with insulation material, in particular on a no-frost refrigeration appliance, in which the evaporator is accommodated in an evaporator chamber which communicates with a storage chamber so that operating noise output from the evaporator into the air of the evaporator chamber can largely propagate freely into the storage chamber.

Further features and advantages of the invention will emerge from the description of exemplary embodiments provided below, with reference to the attached figures. In the figures:

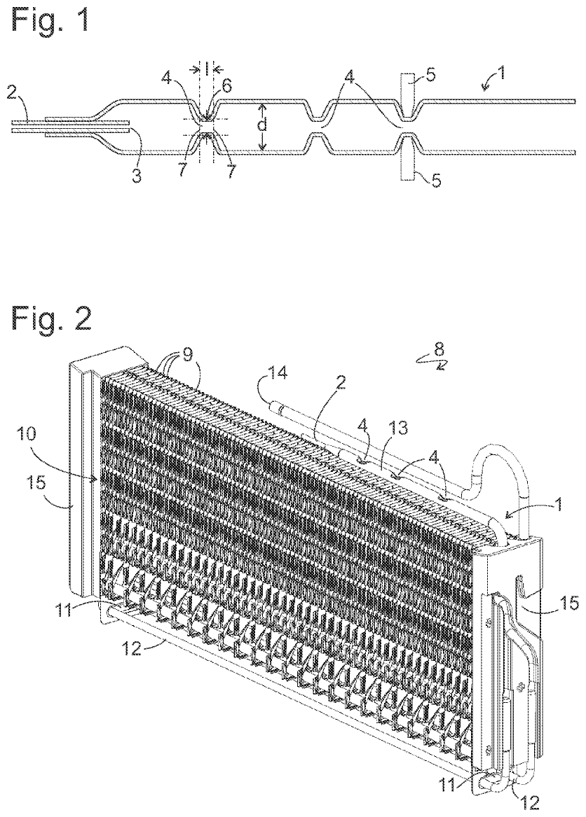

FIG. 1 shows a longitudinal section through a refrigerant line of an inventive evaporator;

FIG. 2 shows a fin evaporator according to a first embodiment of the invention;

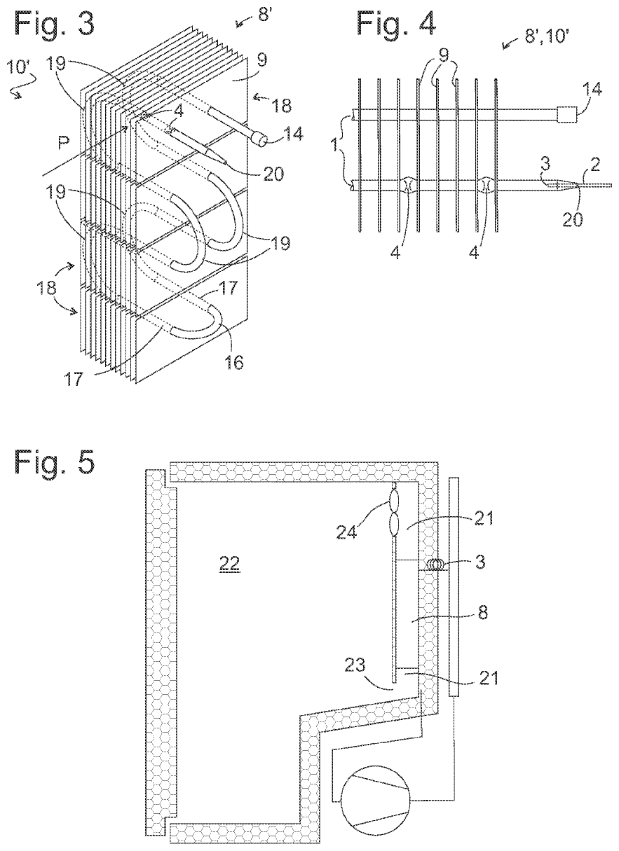

FIG. 3 shows a fin evaporator according to a second embodiment of the invention;

FIG. 4 shows a detail of the fin evaporator from FIG. 3; and

FIG. 5 shows a schematic section through a household refrigeration appliance with an evaporator according to FIG. 2 or 3.

FIG. 1 shows the principle of the invention using a longitudinal section through an upstream section of a refrigerant line 1 of an evaporator. The refrigerant line is formed in a manner known per se by a flexible metal pipe, typically made from aluminum or copper. The pipe manufactured originally with a cross-section which remains constant across its length is tapered at its upstream end so that it rests on the exterior of an inserted capillary 2, and is closely soldered thereto. The end of the capillary 2 forms an injection point 3 at which refrigerant enters the evaporator. This refrigerant can be partially liquid and partially vaporous, which results in irregular fluctuations of the mass flow through the capillary 2 and thus in compression waves which propagate out in the refrigerant line 1 from the injection point 3.

In order to dampen a propagation of these compression waves along the refrigerant line 1, a number of constrictions 4 are molded in the refrigerant line 1 by compressing the pipe, e.g. with the aid of pliers. The constrictions 4 can be molded in a reproducible manner with a constant cross-section if jaws 5 of the pliers have a stop which prevents the jaws 5 from moving further together before the refrigerant line 1 compressed between the jaws 5 is closed completely.

The formation of the constrictions 4 by bending the wall of the refrigerant line 1 means that the cross-section of the refrigerant line 1 increases and decreases continuously past each constriction 4. This continuous change in cross-section facilitates a low-noise, less turbulent flow at the constrictions 4.

Each constriction 4 has in each case a narrowest point 6, from which the cross-section in and against the flow direction of the refrigerant gradually increases. The distance between the two points 7 on both sides of the narrowest point 6 can be considered to be the length l of the constriction 4, at which points the free cross-section of the refrigerant line 1 is in each case twice as large as at the narrowest point 6. In order to keep a drop in pressure at the constriction 4 low, this length l is smaller here than the diameter d of the refrigerant line 1 away from the constrictions 4. The distance of the constrictions 4 from one another and from the injection point 3 is a multiple of this diameter.

FIG. 2 shows a perspective view of an evaporator 8 according to a first embodiment of the invention. This is a fin evaporator for vertical installation in an evaporator chamber on a rear wall of a refrigeration appliance, having a cuboid block 10 of heat exchanger plates 9 which are parallel to one another and at right angles to a longest dimension of the evaporator block and a refrigerant line 1, which runs in meanders through the evaporator block 10, wherein in each case straight sections of the refrigerant line 1 intersect the heat exchanger plates 9 at right angles, and curved parts which connect the straight sections in series with one another engage in bypass blockers 15 which cover two narrow sides of the block 10. The two outermost heat exchanger plates 9 of the block 10 are lengthened downward in order to form retaining holes 11 for a defrost heater 12 which extends below the block. An upstream section 13 and a downstream section with an outlet 14 of the refrigerant line 1 project in each case above a top side of the block. The upstream section 13 extends largely parallel to the top side of the block 10 and the straight sections of the refrigerant line 1 which run in the block 10. Its inlet-side end is tapered, as shown in FIG. 1, in order to receive the capillary which is not shown in FIG. 2. The upstream section 13 is impressed at several points in order to form a constriction 4 in each case. These dampen compression waves propagating out from the injection point in the refrigerant flow of the line 1 before these can reach the block 10, and thus reduce the noise emission through the heat exchanger plates 9.

If there is no space available in the surroundings of the block 10 to accommodate an upstream section of the refrigerant line there, then the constrictions must be created in the evaporator block itself. The problem here is that if a constriction is created by compressing the refrigerant line 1 in a first direction, the dimension of the refrigerant line 1 can increase in a second direction which is at right angles to the first, and that as a result it may be impossible to thread heat exchanger plates 9 with holes that are closely tolerated in the interests of a good thermal transmission onto the refrigerant line. FIG. 3 shows such an evaporator 8′. The evaporator 8′ is assembled by the refrigerant line 1 firstly being curved in the shape of a hairpin with a first curve 16 and straight limbs 17 adjoining the same, and heat exchanger plates 9 with two holes in each case being moved successively onto the limbs 17. In the case shown here, the heat exchanger plates 9 are arranged along the limbs 17 in several groups 18, which, by subsequently deforming the sections of the limbs 17 connecting them to form second curves 19, come to rest one above the other and thus form a shared block 10′. Here the distance between the upstream end 20 of the refrigerant pipe 1 (or the injection point 3) and the first heat exchanger plate 9 in the flow direction, which intersects the refrigerant line 1, is too small to accommodate the required constrictions there. In order to mold the constrictions, pliers can be inserted here into an intermediate space between two heat exchanger plates 9, e.g. from the direction of the arrow P, in order to compress the refrigerant pipe 1 in the intermediate space at right angles to the direction of the arrow.

FIG. 4 shows the resulting configuration in a top view onto a part of the top side of the block 10′. The refrigerant line 1 compressed at constrictions 4 in the viewing direction is widened at right angles to the viewing direction so that it no longer passes through the holes of the heat exchanger plates 9 adjacent to the constrictions.

FIG. 5 shows a schematic section through a household refrigeration appliance with an evaporator 8 according to the invention. The evaporator 8 is accommodated here in a vertical orientation in an evaporator chamber 21 on the rear wall of the appliance. The evaporator chamber 21 communicates with a storage chamber 22 for refrigerated goods by way of inlet and output openings 23, 24. Naturally in other embodiments the household refrigeration appliance can also have a number of storage compartments which are preferably maintained at different temperatures. A horizontal orientation of the evaporator, e.g. in an evaporator chamber which extends on a ceiling of the storage chamber or in an intermediate wall between two storage chambers could also be considered.

### REFERENCE CHARACTERS

1 Refrigerant line
2 Capillary
3 Injection point
4 Constriction
5 Jaws
6 Narrowest point
7 Point
8 8′ Evaporator
9 Heat exchanger plate
10 10′ Block
11 Retaining hole
12 Defrost heater
13 Upstream section
14 Outlet
15 Bypass blocker
16 Curve
17 Limb
18 Group
19 Curve
20 Upstream end
21 Evaporator chamber
22 Storage chamber
23 Inlet opening
24 Outlet opening

1-11. (canceled)

12. An evaporator for a refrigeration appliance, the evaporator comprising:
a refrigerant line extending from an injection point to an outlet of the evaporator;
a number of heat exchanger plates each connected in thermal contact with said refrigerant line and in thermal contact with surroundings of the evaporator;
said refrigerant line, in an upstream region of the evaporator, being formed with at least one constriction that is spaced apart from said injection point.

13. The evaporator according to claim 12, wherein at least one of the following is true: a free cross-section of said constriction is larger than a free cross-section of said injection point, or a length of said constriction is smaller than a diameter of said refrigerant line away from said constriction.

14. The evaporator according to claim 12, wherein a distance of said at least one constriction from said injection point is a multiple of a diameter of said refrigerant line.

15. The evaporator according to claim 12, wherein said at least one constriction is one of a plurality of restrictions and wherein a distance of a constriction from said injection point or from an adjacent injection point is a multiple of a diameter of said refrigerant line.

16. The evaporator according to claim 12, wherein said refrigerant line and each said heat exchanger plate are components which differ from one another and are connected to one another by at least one of clamping, adhesion, or soldering.

17. The evaporator according to claim 12, wherein said constriction is formed by an impression in a wall of said refrigerant line.

18. The evaporator according to claim 12, wherein said refrigerant line runs in a straight line between said injection point and said at least one constriction.

19. The evaporator according to claim 12, wherein said number of heat exchanger plates is a multiplicity of mutually parallel heat exchanger plates and said refrigerant line intersects said heat exchanger plates.

20. The evaporator according to claim 12, wherein said at least one constriction is formed on a section of said refrigerant line that extends between said injection point and a most upstream contact point between said refrigerant line and said number of heat exchanger plates.

21. The evaporator according to claim 19, wherein said at least one constriction is formed in a section of said refrigerant line that extends between two said heat exchanger plates.

22. A refrigeration appliance, comprising an evaporator according to claim 12.

23. The refrigeration appliance according to claim 22 formed as a household refrigeration appliance.

24. The refrigeration appliance according to claim 22, formed with a storage chamber and an evaporator chamber which communicates with said storage chamber, and wherein said evaporator is accommodated in said evaporator chamber.
